(19) United States
(12) Patent Application Publication
(10) Pub. No.: US 2025/0012294 A1
(43) Pub. Date: Jan. 9, 2025

(54) TURBO MACHINE AND METHOD FOR MANUFACTURING

(71) Applicant: CRYOSTAR SAS, HESINGUE (FR)

(72) Inventors: Stephane SGAMBATI, HESINGUE (FR); Anny MURAD-BICKARD, HESINGUE (FR)

(21) Appl. No.: 18/711,953

(22) PCT Filed: Nov. 21, 2022
(86) PCT No.: PCT/EP2022/025525

§ 371 Date: May 21, 2024

(30) Foreign Application Priority Data
Nov. 26, 2021 (EP) 21315248.1

(51) Int. Cl. F04D 29/46; F01D 17/16; F04D 29/02; F04D 29/56

(52) U.S. Cl. CPC F04D 29/462; F01D 17/16; F04D 29/02; F04D 29/563; F05D 2220/30; F05D 2230/30; F05D 2240/12; F05D 2300/611

(57) ABSTRACT

A turbo machine with a shaft, an impeller arranged on said shaft, and one or more guide vanes configured to guide operating fluid to or from said impeller, wherein the one or at least one of the more guide vanes is movably arranged in the turbo machine and arranged in relation to one or more components of said turbo machine such that said one or at least one of the more guide vanes abuts said one or more components and that said one or at least one of the more guide vanes is movable relative to said one or more components, wherein at least one contact surface between said one or at least one of the more guide vanes and said one or more components comprises a diamond like carbon coating. The invention also relates to a method of manufacturing such turbo machine.

The present invention relates to turbo machine, e.g., a cryogenic turbo machine, with an impeller mounted on a shaft and one or more guide vanes, and to a method of manufacturing such turbo machine.

### BACKGROUND

Turbo machines can be used in different applications. For example in cryogenic applications, i.e. applications with process gases at cryogenic temperatures, e.g., plants for air separation or the like, cryogenic turbo machines like turbo expanders and/or compressors are often used. Such turbo machines typically comprise an expander impeller and/or a compressor impeller, which are fixed on a shaft.

Such turbo machines typically also comprise guide vanes configured to guide operating fluid, e.g., gas like the mentioned process gas, to or from such impeller. Such guide vanes can be movably arranged in the turbo machine in order to change the angle with which the fluid arrives on or leaves the impeller. Moving guide vanes can cause wear, scratches and rubbing; this can lead to the turbo machine (and possibly other parts of a system) to get stuck. It is therefore an object of the present invention to provide an improved turbo machine.

### DISCLOSURE OF THE INVENTION

This object is achieved by providing a turbo machine and a method of manufacturing such a turbo machine with the features of the independent claims. Embodiments of the invention are the subject of the dependent claims and of the description that follows.

The invention relates to turbo machines, in particular cryogenic turbo machines, like turbo compressors or turbo expanders with an impeller arranged or mounted on a shaft. Cryogenic turbo machines are used with operating fluid like gases or process gases at cryogenic temperatures, i.e., very low temperatures of, e.g., less than-100° C. at the expander outlet or at the compressor inlet. Depending on the kind of turbo machine, such gases are compressed and/or expanded. Turbo machines in other applications can also be used with operating fluids at higher temperatures.

Such turbo machine also comprises one or more guide vanes configured to guide operating fluid, e.g., gas like the mentioned process gas, to or from the impeller. Typically, several guide vanes are arranged, preferably, in an equally distributed manner. These guide vanes are used to properly guide or direct the fluid in a desired manner or desired angle onto the impeller (for an expander) or away from the impeller (for a compressor).

One or several or all of such guide vanes (often also referred to as nozzles) can be movably arranged in the turbo machine in order to change the angle with which the fluid arrives on or leaves the impeller. This allows, for example, regulating the flow according to process requirements, changing efficiency and the like. The guide vanes can be moved, e.g., continuously and/or with small steps. In particular, the turbo machine can be configured to automatically move the guide vanes, e.g., according to current needs.

These guide vanes can be arranged in relation to one or more (other) components of the turbo machine, e.g., support rings, such that the guide vanes are in contact with this one or more components and such that the guide vanes are movable relative to such one or more components. This avoids any bypassing of operating fluid flowing along the guide vanes and onto or from the impeller; aerodynamic expansion and/or compression efficiency is increased in this way.

Since frequencies and amplitudes of the moving or displacements of moving of such guide vanes are variable, this can cause wear, scratches and rubbing; this can lead to the turbo machine (and possibly other parts of a system) getting stuck. The flow can then not be modified anymore and not be adapted to the process requirements. The turbo machine needs then to be stopped and dismantled.

It has now been recognized that providing diamond like carbon coating very efficiently reduces friction between the guide vanes and other components, i.e., when at least one contact surface between said one or at least one of the more guide vanes and said one or more components comprises a diamond like carbon coating. In particular, such diamond like carbon coating (also referred to as diamond like coating or just diamond like carbon) efficiently reduces friction also for low operating temperatures, i.e., it can be used in cryogenic turbo machines.

Said at least one contact surface can comprise at least one surface of said one or at least one of the more guide vanes. Also, said at least one contact surface can comprise at least one surface of said one or more components. In order to even more reduce friction and to even better avoid wear, the contact surfaces can comprise both, i.e., diamond like carbon coating is provided on the guide vane(s) and the one or at least one of the more components.

Diamond like carbon coating—also referred to as diamond like coating or just diamond like carbon (DLC)—is a class of amorphous carbon (a-C) material that displays some of the typical properties of diamond, and also of graphite. Diamond like carbon can be applied as coatings to other materials that could benefit from such properties. Diamond like carbon exists in different forms. All forms typically contain significant amounts of sp³ hybridized carbon atoms. The reason that there are different types is that even diamond can be found in two crystalline polytypes. The more common one uses a cubic lattice, while the less common one, lonsdaleite, has a hexagonal lattice. By mixing these polytypes at the nanoscale, diamond like carbon coatings can be made, which at the same time are amorphous, flexible, and yet purely sp³ bonded “diamond”. Fillers such as hydrogen (H), tungsten (W), graphitic sp² carbon, and other metals can be used to reduce production expenses or to impart other desirable properties. Also, additional layers (also indicated with a “+” symbol) like chrome nitride (CrN) can be used, which typically are provided between the support material and the actual diamond like carbon. Then, the diamond like carbon coating can be considered comprising diamond like carbon and a further layer.

Preferred diamond like carbon forms to be provided at the surfaces of the guide vanes and/or other components comprise at least one of: a-C:H:W, a-C:H:W+a-C:H, CrN+a-C:H, a-C:H, Cr+a-C:H:W, Cr+a-C:H:W+a-C:H, Cr+CrN+a-C:H, Cr+a-C:H.

The invention also relates to a method for manufacturing such turbo machine as described above. Said method comprises providing said at least one contact surface with said diamond like carbon coating, i.e., said diamond like carbon coating is provided onto said one or at least one of the more guide vanes and/or onto said one or more components. This can be by at least one of: CVD (Chemical Vapour Deposition) or PVD (Physical Vapour Deposition). The PVD methods can be divided into: arc, sputter, and laser vapour deposition methods. The CVD methods like plasma-assisted chemical vapour deposition (PACVD), or plasma enhance chemical vapour deposition, (PECVD) methods can be divided into: radio-frequency (RF), direct current (DC) discharge, Penning ionization gauge (PIG), and self-discharge methods.

The provision of the diamond like carbon coating typically takes place before assembling the entire turbo machine, such that the guide vanes and/or components to be provided with the coating, are accessible.

Plasma-assisted chemical vapour deposition is a chemical vapour deposition process used to deposit thin films from a gas state (vapour) to a solid state on a substrate. Chemical reactions are involved in the process, which occur after creation of a plasma of the reacting gases. The plasma can be created by radio frequency (RF), using alternating current (AC) frequency, or direct current (DC) discharge between two electrodes, the space between which is filled with the reacting gases.

Ion beam deposition (IBD) is a process of applying materials to a target through the application of an ion beam. https://en.wikipedia.org/wiki/File:Ion_implanter_schematic.png An ion beam deposition apparatus typically consists of an ion source, ion optics, and the deposition target. Optionally a mass analyser can be incorporated. In the ion source, source materials in the form of a gas, an evaporated solid, or a solution (liquid) are ionized. For atomic IBD, electron ionization, field ionization (Penning ion source) or cathodic arc sources are employed. Cathodic arc sources are used particularly for carbon ion deposition. Molecular ion beam deposition employs electrospray ionization or so-called MALDI sources.

Sputter deposition is a physical vapour deposition (PVD) method of thin film deposition by sputtering. This involves ejecting material from a “target” that acts as a source onto a “substrate” such as the guide vane or the other components, which are typically made of metal like steel.

Depending on the desired thickness and/or hardness of the DLC coating, for example, an appropriate deposition method can be chosen. we can get thicker or smoother or harder coatings.

The advantages of the present invention are, in particular, reducing the friction coefficient and avoiding any stuck of the guide vanes (or nozzle) when moving them. This, in particular, is possible for low temperatures like down to −100° C. and below at the guide vanes, what is a typical temperature for operational fluid at the guide vanes in cryogenic turbo machines.

### SHORT DESCRIPTION OF THE FIGURES

FIG. 1 illustrates a turbo machine according to a preferred embodiment of the invention.

FIG. 2 illustrates a turbo machine according to a further preferred embodiment of the invention.

FIGS. 3 to 5 illustrate different parts of the turbo machine of FIG. 2 in more detailed views.

FIG. 6 illustrates a manufacturing method according to a preferred embodiment of the invention.

### DETAILED DESCRIPTION OF THE FIGURES

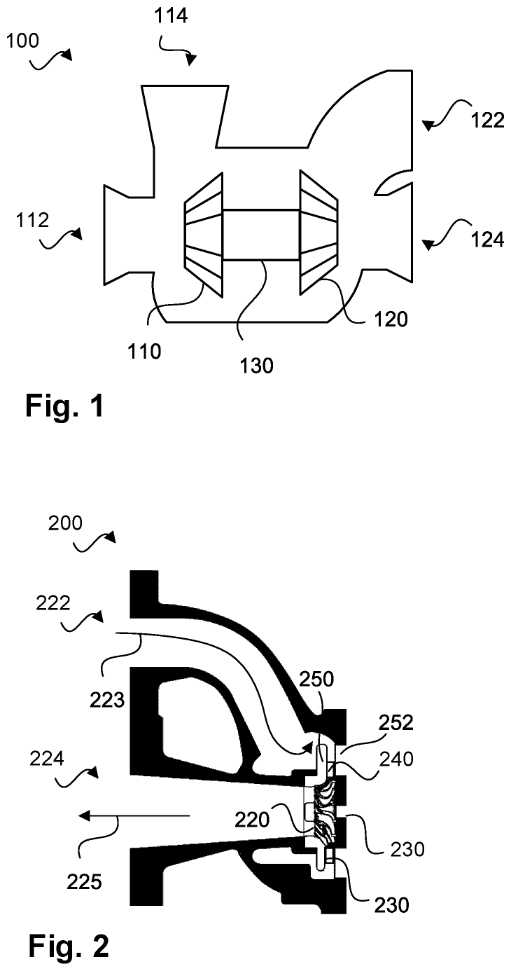

FIG. 1 schematically illustrates a turbo machine 100 according to a preferred embodiment of the invention. The turbo machine 100, e.g., a cryogenic turbo machine is, by means of example, configured as a compressor and an expander, i.e., both are combined in one turbo machine. Turbo machine 100 comprises, hence, two impellers, an impeller 110 and an impeller 120, both mounted on a shaft 130. The turbo machine 100 comprises openings 112 and 114 on the side of the impeller 110, the openings used respectively as inlet and outlet for the operating fluid to be compressed. The turbo machine 100 further comprises openings 122 and 124 on the side of the impeller 120, the openings used respectively as inlet and outlet for the operating fluid to be expanded. Thus, the impeller 110 is a compressor impeller and the impeller 120 is an expander impeller. The operating fluid to be compressed and the operating fluid to be expanded can have identical or can have different properties like pressure, temperature, chemical composition etc.

FIG. 2 schematically illustrates a turbo machine 200 according to a further preferred embodiment of the invention e.g., a cryogenic turbo machine, in a cross section. The turbo machine 200 is, by means of example, configured as an expander and as radial turbo machine or radial turbine. It is noted that the parts shown in FIG. 2 can also be combined with compressor parts like shown for turbo machine 100 in FIG. 1. The turbo machine 200 is similar to the expander part of turbo machine 100, however, showing more details.

Turbo machine 200 comprises an impeller 220, mounted on a shaft 230. The turbo machine 200 comprises openings 222 and 224 on the side of the impeller 220, the openings used as inlet 222 and outlet 224 for operating fluid to be expanded. An inlet flow of operating fluid is denoted 223, and an outlet flow of operating fluid is denoted 225.

The turbo machine 200 comprises several guide vanes 240 movably arranged therein and arranged in relation to, by means of example, two components in the form of support rings 250 and 252. A channel following the inlet 222 is formed such that the operating fluid (See flow 223) is guided from radial outwards in the direction of the guide vanes 240.

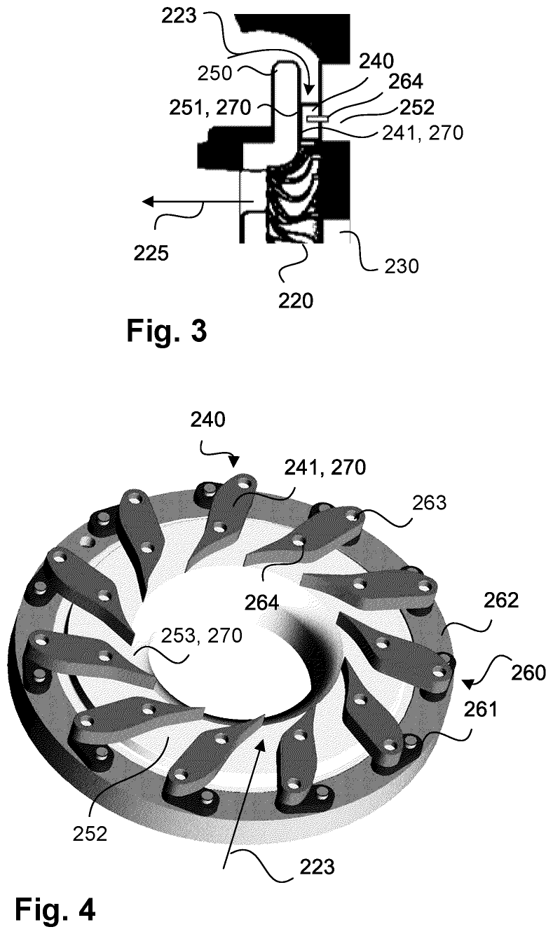

FIG. 3 illustrates an enlarged view of the part of FIG. 2 showing the upper guide vane 240. FIG. 4 illustrates, in an example, a perspective view of the support ring 252 and several, equally distributed guide vanes 240. In particular, these Figs. illustrate the flow 223 being guided in the direction of the guide vanes 240; the operating fluid will then flow between adjacent guide vanes 240 and reaches the impeller 220.

Each of the guide vanes 240 is mounted onto the support ring 252 by means of a pin 264, for example, such that the guide vane 240 is movable relative to the support ring 252. This can be performed, for example, by means of a moving arrangement 260, comprising an (outer) ring 262 having support elements 261 therein, each of which is connected to a respective guide vane 240 by means of a pin 263. When the ring 262 is slightly rotated in the one or the other direction, the guide vanes 240 are moved such that the angle or direction for the flow 223 is changed.

As can be seen from FIGS. 3 and 4, there are contact surfaces between each of the guide vanes 240 and each of the two support rings 250, 252. These contact surfaces comprise a surface 241 of each guide vane 240 (see FIGS. 3 and 4) and the opposing surface of each of these each guide vanes 240. These contact surfaces further comprise a surface 253 of the support ring 252 (the surface, which is oriented in direction of the guide vanes) and a surface 251 of the support ring 250 (also the surface, which is oriented in direction of the guide vanes).

When the guide vanes 240 are moved as described above, the mentioned contact surfaces, abutting each other, move relative to each other; this can cause wear, scratches and rubbing, in particular, because frequencies and amplitudes of the moving or displacements of such moving guide vanes are variable.

In order to reduce the friction coefficient between these contact surfaces and to avoid (or at least reduce) wear, scratches and rubbing, a diamond like carbon coating 270 is provided on the respective components, the guide vanes 240 and the support rings 250, 252, such that the mentioned contact surfaces comprises said diamond like carbon coating 270. It is noted that such diamond like carbon coating 270 should, preferably, be provided at every possible area of contact.

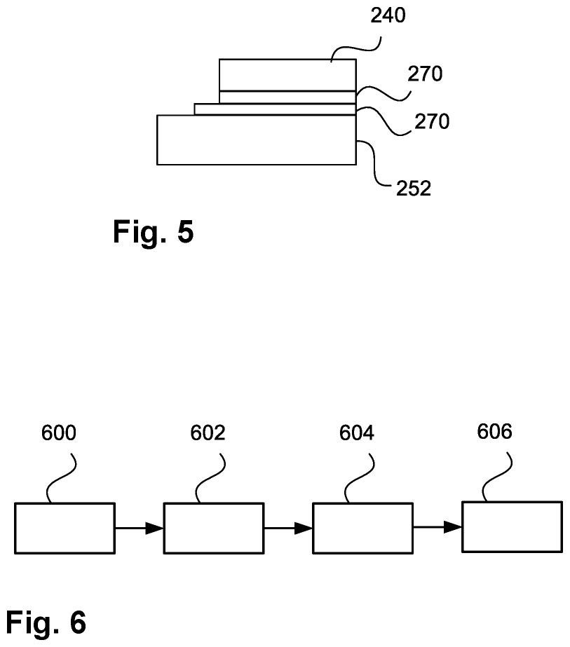

FIG. 5 illustrates, in a cross section, a guide vane 240 (or part of it) and the support ring 252 (or part of it) and a diamond like carbon coating 270 on each of the guide vane 240 and the support ring 252. Moving the guide vane 240 (with the ring 252 being static) leads to a relative movement between the two diamond like carbon coatings 270 shown here. Friction between these two diamond like carbon coatings 270 is very low and wear, scratches and rubbing are avoided.

FIG. 6 illustrates, by means of flow diagrams, a manufacturing method according to a preferred embodiment of the invention. The method comprises, in a step 600, providing the guide vanes and the support rings (or other components) that shall be coated with diamond like carbon. In a step 602, the guide vanes are provided with the diamond like carbon coating or their surfaces. In a step 604, the support rings are provided with the diamond like carbon coating or their respective surfaces. After having coated all relevant parts or components, in a step 606, these parts or components—and other necessary parts—are assembled together to form the turbo machine. It is noted that parts of the turbo machine can also be assembled prior to adding the guide vanes and/or support rings.

The way of how to provide the diamond like carbon coating (deposition method) in step 602 and/or in step 604 is, e.g., one of chemical vapour deposition (CVD), or physical vapour deposition (PVD). PVD methods can be divided into, e.g. arc, sputter, and laser vapour deposition methods. CVD methods can be divided into, e.g., radio-frequency (RF), direct current (DC) discharge, Penning ionization gauge (PIG), and self-discharge methods. Depending on the specific needs or requirements, different deposition methods can be used in step 602 and in step 604, i.e., the guide vanes on the one hand and the support rings on the other hand can be coated in the same way or in different ways; this may lead to different kind of diamond like carbon coatings, some of which are mentioned above.

1. A turbo machine with a shaft, an impeller
arranged on said shaft, and one or more guide vanes configured to guide operating fluid to or from said impeller,
wherein the one or at least one of the more guide vanes is movably arranged in the turbo machine and arranged in relation to one or more components of said turbo machine such that said one or at least one of the more guide vanes is in contact with said one or more components and that said one or at least one of the more guide vanes—is movable relative to said one or more components,
wherein at least one contact surface between said one or at least one of the more guide vanes and said one or more components comprises a diamond like carbon coating.

2. The turbo machine of claim 1, wherein said at least one contact surface comprises at least one surface of said one or at least one of the more guide vanes.

3. The turbo machine of claim 1, wherein said at least one contact surface comprises at least one surface of said one or more components.

4. The turbo machine of claim 1, wherein said diamond like carbon coating comprises at least one of: a-C:H:W, a-C:H:W+a-C:H, CrN+a-C:H, a-C:H, Cr+a-C:H:W, Cr+a-C:H:W+a-C:H, Cr+CrN+a-C:H, Cr+a-C:H.

5. The turbo machine of claim 1, wherein said one or at least one of the more components is statically fixed within the said turbo machine.

6. The turbo machine of claim 1, wherein said one or at least one of the more components is configured as support ring.

7. The turbo machine of claim 1, configured to move said one or at least one of the more guide vanes automatically.

8. The turbo machine of claim 1, configured as a cryogenic turbo machine.

9. The turbo machine of claim 1, configured as a radial turbo machine.

10. The turbo machine of claim 1, configured as an expander.

11. The turbo machine of claim 1, configured as a compressor.

12. A method for manufacturing the turbo machine of claim 1, comprising: providing said at least one contact surface with said diamond like carbon coating.

13. The method of claim 12, wherein said diamond like carbon coating is provided onto said one or at least one of the more guide vanes and/or said one or more components by at least one of: chemical vapour deposition, physical vapour deposition.

14. The method of claim 13, wherein chemical vapour deposition comprises at least one of: plasma-assisted chemical vapour deposition, plasma enhance chemical vapour deposition, and/or wherein chemical vapour deposition comprises at least one of: radio-frequency, direct current discharge, Penning ionization gauge, and self-discharge methods.

15. The method of claim 13, wherein physical vapour deposition comprises at least one of: arc, sputter, and laser vapour deposition methods.
